(19) United States
(12) Patent Application Publication
(10) Pub. No.: US 2022/0410848 A1
(43) Pub. Date: Dec. 29, 2022

(54) MOVABLE AUTOMOBILE WASHING DEVICE AND SYSTEM WITH FLUID RECYCLING

(71) Applicant: Donald B. Parr, Pulaski, TN (US)

(72) Inventor: Donald B. Parr, Pulaski, TN (US)

(21) Appl. No.: 17/716,814

(22) Filed: Apr. 8, 2022

Related U.S. Application Data
(63) Continuation of application No. 16/576,222, filed on Sep. 19, 2019, now abandoned.
Application No. 16/576,222 is a continuation-in-part of application No. 15/870,964, filed on Jan. 14, 2018, now abandoned.

(51) Int. Cl. B60S 3/04

(52) U.S. Cl. CPC B60S 3/04

(57) ABSTRACT

The present disclosure provides a movable device and system for the application of pressurized fluid, collection of that fluid, and cleaning and recycling of that fluid for subsequent use. An application of the current device is in the washing of items, for example, automobiles.

### CROSS REFERENCE TO RELATED APPLICATIONS

This application claims priority benefit of the filing dates of U.S. patent application Ser. No. 16/576,222, filed Sep. 19, 2019 and U.S. patent application Ser. No. 15/870,964, filed Jan. 14, 2018, the contents of which are incorporated herein by reference in their entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

All patents and publications described or discussed herein are hereby incorporated by reference in their entirety.

### BACKGROUND

### Technical Field

The present disclosure relates to a washing system. More particularly, the present disclosure relates to a moveable automobile wash appliance which is chattel property rather than a permanent fixture. This appliance can recover, reclaim and reuse the water used during the wash process for subsequent use by the system. This device can be removed from one location and reinstalled at another location without causing damage to the property. Generally, the automobile washing systems, sometimes called carwashes or carwash stations, are known in the art. Most of these systems are commercial-based carwashes in which vehicles move through an automated machine. Alternately, the commercial carwashes includes individual bays for manual washing. Some of these stations or bays have some type of water reclamation system. However, this reclamation typically involves components permanent built into the location of the car washing station.

Additionally, portable spray washers, spray thamers, and the like are known in the art. These devices typically will attach to a water supply system and provide high pressured fluid, such as water, for some desired process. These devices can introduce chemicals into the spray or water discharged.

Some of the prior art attempts in this area include the following U.S. Pat. Nos. 4,315,270; 4,309,788; 4,383,935; 5,897,297; 5,996,907; 6,571,805; 7,344,640; 7,959,091; and 8,556,192.

Problems associated with prior devices include their requirement to become a part of the building structure rather than becoming temporarily attached to the existing structure. Prior devices required digging trenches to collect used washwater in pump basins so it could be pumped back into their water treatment devices.

Additional problems associated with these prior devices include a lack of portability or a lack of recycling in the systems. Generally, the portable devices lack any means to recycle the fluid to which they are using. Most of the portable devices simply attach to a fluid line, or have tanks with fluid in them and simply produce that fluid out a hose or nozzle for the desired process, such as cleaning an object. Alternately, the prior items that have a recycling component or a cleaning component are restricted to a particular location. This is due to the fact that the cleaning or recycling portion is permanently imbedded at the location of the cleaning. For example, the automated carwashes or carwash bays that have recycling or cleaning capabilities have those abilities fixed typically underground or below the surface level at the location of the facility.

What is needed then is an efficient, effective chattel device used to clean objects, such as automobiles, and possessing the capability to recycle the fluid used during cleaning. Preferably the recycling of the fluid includes a cleansing or cleaning of the fluid within the needed device. This device is lacking in the art.

### BRIEF SUMMARY

The present disclosure provides a chattel device and system for the application of pressurized fluid, collection of that fluid, and cleansing and recycling of that fluid for subsequent use. An application of the current device is in the washing of items, for example, automobiles.

In an embodiment, the system includes a frame that supports and houses the various components. A vacuum air pump 20 is operatively attached to an intake conduit 22. The intake conduit 22, from a force from the vacuum air pump 20, conveys fluid along with air into a vacuum tank 18 wherein the fluid settles. The discharge port 24 from tank 18 is a check valve 24 which is held in a closed position by the vacuum pressure on the inside of the tank 18. When the fluid level collected inside the tank reaches the level of a liquid sensor 19, the system controller 11 causes the vacuum pump to turn off until the collected fluid has flushed out of the tank 18. The system controller 11 turns the vacuum pump 20 on to resume water collection after a sufficient time delay necessary to empty tank 18 by gravitational force.

The fluid from vacuum tank 18 is discharged into a first cleansing tank 12 that is designed to separate oils and settleable solids from the fluid. In the first liquid holding compartment, a coagulant can be introduced via conduit 52 and pump 48 to further solidify dissolved and/or settleable particles within the fluid to have those particles drop to the bottom of the first and second liquid holding compartment. A baffle 26 is used as a barrier to prevent oil from reaching the pass-thru opening 28 which allows fluid to flow into tank 14.

An air pump 27 with an aerator stone 51 can introduce air into the first liquid holding compartment. This can prevent the reproduction of odor causing bacteria. The fluid is transferred to a second liquid holding compartment 14 which serves as a clarifier. The fluid then rises through a lamella-style plate clarifier 32 to further separate impurities from the fluid. Once the liquid has passed through the lamella-style clarifier, it can flow into the top back portion of the second liquid holding compartment 30. There, a predetermined portion of the treated fluid can be discharged by a discharge pump 34 out of the system into the sanitary sewer via discharge conduit 35. The length of time that the discharge pump 34 is turned on is determined by the system controller 11. The system controller 11 has a digital display screen where the discharge pump 34 on-time duration can be set dependent on the reclaim water percentage.

The remaining fluid can then be transferred to a third tank 16. The third tank 16 serves as a reclaimed water reservoir. If there has been some fluid lost in the process, a float valve 47 can determine what amount is needed and add the required amount in this third tank 16 via a fresh water line 46. An exit 40 from the third tank 16 is operatively attached to a pressure pump 42 and discharge conduit 44 wherein the processed fluid can then be reused for its intended purpose.

It is, therefore, a general object of the current disclosure to provide a movable washing system that reclaims fluid for use in the washing process. A system that reclaims and processes fluid used during the washing process for subsequent use by the same device.

Another object of the current disclosure is the reclamation of fluid used in a washing process that allows, meets or exceeds pretreatment regulations for automobile wash discharge from the fluids reclaimed during the automobile washing process.

Another object of the current disclosure is to provide a system for the reclamation of water during a washing process that reduces the overall cost of the water used in the process.

The present invention may be movable or portable by being free/not attached from/to the support surface of the present invention.

Numerous other objects, features and advantages of the present invention will be readily apparent to those skilled in the art upon a reading of the following description when taken in conjunction with the accompanying drawings.

### BRIEF DESCRIPTION OF THE DRAWINGS

FIG. 1 is a schematic drawing of a system made in accordance with the current disclosure.

FIGS. 2, 3 and 4 are schematic drawings of each tank 12, 14 and 16 and the structures above each tank of the system made in accordance with the current disclosure. Each figure shows a perspective view from the front and left side of the appliance compartment

FIGS. 5, 6, 7, and 8 are schematic drawings of each tank 12, 14, and 16 and the external component cabinet made in accordance with the current disclosure.

### DETAILED DESCRIPTION

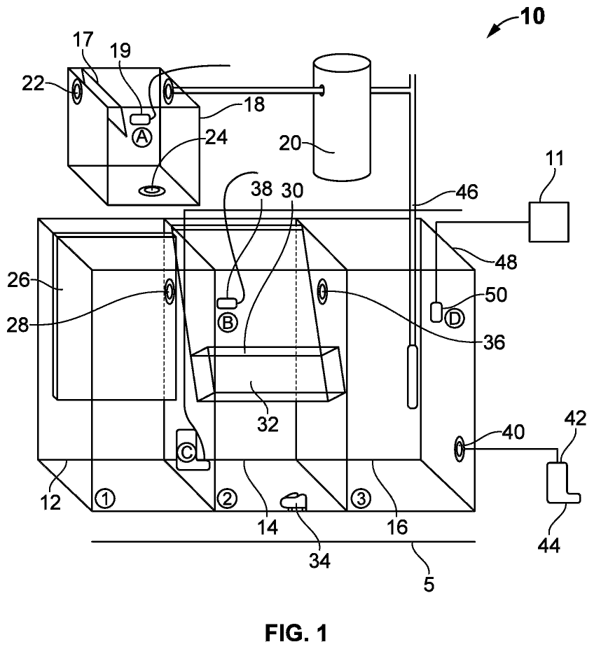

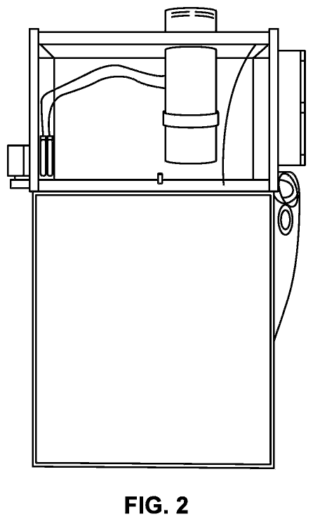

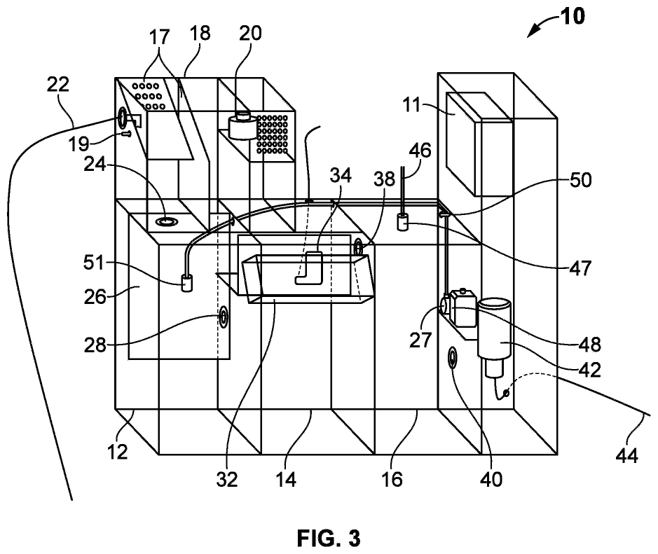

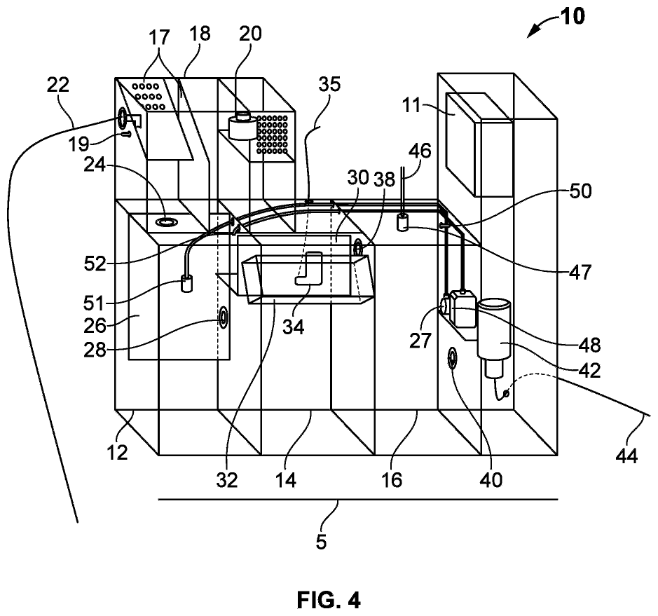

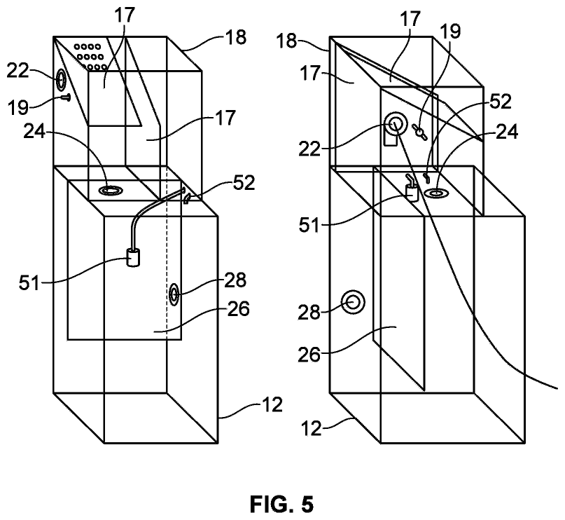

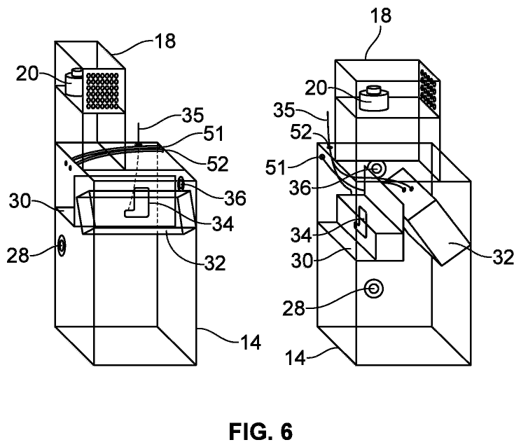

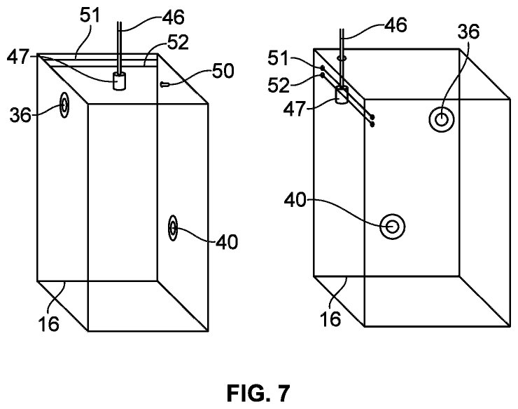

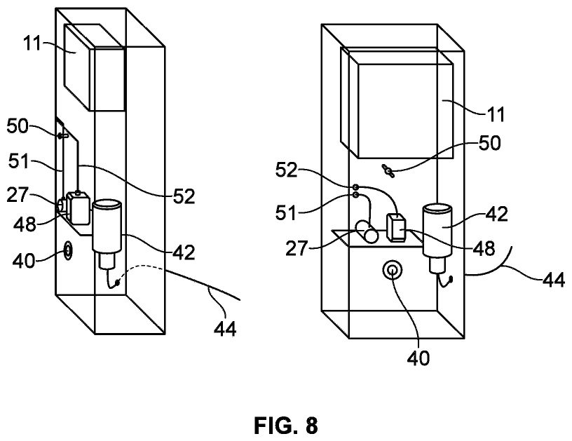

Referring now generally to FIGS. 1-8 as one embodiment of the present disclosure provides a system 10 for the reclamation of wastewater during a washing process. The system 10 may be movably connected to the support surface 5 which may be a concrete floor. The system 10 includes first, second, and third liquid holding compartments/containers 12, 14, and 16 respectively, which can also be described as holding tanks or processing tanks. These liquid holding compartments 12, 14, and 16 are fluidly connected to each other.

The first liquid holding compartment 12 is connected to a vacuum tank 18 above the holding tank 12, which is operatively attached to a vacuum pump 20 and an intake conduit 22. The intake conduit 22 conveys the fluid, which may be contaminated from the washing process, by a force imparted by the vacuum 20 through the vacuum tank 18. Intake conduit 22 can be those items known in the industry to convey fluid, such as a hose/pipe with a proper receptacle at the end. Alternately, the intake conduit 22 may be a collection tank used to collect the fluid used in the washing process.

The fluid can be moved through the intake conduit 22 and into the vacuum tank 18 by a vacuum pump 20. Within the vacuum tank 18, there can be a vacuum tank baffle/panel 17 used to direct the fluid into a desired location within the vacuum tank 18. This baffle facilitates the fluid to remain in the vacuum tank 18 and not transferred to the vacuum pump 20. Additionally, a sensor 19 can be positioned within the vacuum tank 18. This vacuum tank sensor 19 can be a safety sensor used to control the vacuum pump 20 when the fluid within the vacuum tank 18 rises to the sensor level. This vacuum fluid sensor 19 indirectly controls the opening 24 in the vacuum tank 18 that communicates with the first liquid holding compartment 12. The opening 24 contains a valve or other fluid control to regulate the flow of fluid from the vacuum tank 18 to the first liquid holding compartment 12. The fluid control device or valve is controlled by the logic controller 11 of the system 10. The fluid flows from the vacuum tank 18 through the opening 24 into the first liquid holding compartment 12.

The fluid enters the first liquid holding compartment 12 through an opening in the top of the first liquid holding compartment 12 and proceeds to a first side of the baffle/panel 26. Particles in the fluid settle to the bottom of the first liquid holding compartment 12. Residual oil from the water based washing process stays on top of the fluid in compartment 12. Because the baffle 26 extends the full width of the first liquid holding compartment 12, the oil will remain on the first side of the baffle and stays in compartment 12 and is periodically removed during appliance maintenance. As the water flows down and around the baffle, the oil does not flow with it. On the second side of the baffle 26 is a first transfer channel 28, or first opening, between the first tank 12 and the second 14.

This first transfer channel 28 can include a filter or valve as desired. This facilitates movement of the liquid from the first holding tank 12 to the second holding tank 14 without oil and settled solids, which stay in compartment 12.

As the liquid transfers to the second holding tank 14, a lamella-style incline plate clarifier 32 is positioned in the middle of the compartment 14, which extends the width of tank 14. A lamella clarifier or inclined plate settler (IPS) is a type of settler designed to remove particulates from liquids.

They are often employed in primary and industrial water treatment in place of conventional settling tanks. Unlike conventional clarifiers, they use a series of inclined plates. These inclined plates provide a large effective settling area for a small footprint. The inlet stream is stilled upon entry into the clarifier. Solid particles begin to settle on the plates and begin to accumulate below the clarifier unit. The clarifier 32 extends the entire width of compartment 14. The fluid travels to the top of the clarifier while solids are settled on the plates and eventually sink to the bottom of compartment 14 and settle there as sludge. The sludge is drawn off at the bottom during appliance cleaning. The clarified liquid exits the clarifier 32 at the top and flows into the discharge compartment 30 separated by a weir with a floor. The weir and the floor extends the entire width of compartment 14. This makes this compartment 30 a contained compartment. Excess fluid is discharged via discharge pump 34. The discharge pump is controlled by a fluid level sensor 50 via the programmable logic controller 11. The pump 34 discharges water without oil, sludge and other contaminants separated in compartment 12 and 14 to the sanitary sewer.

The liquid within the second holding tank 14 will enter the third holding tank 16 above the clarifier 32 through the connector 36. This opening 36 can include an opening 36, enters the third holding tank 16. The third holding tank 16 includes an opening 40 connected to a high-pressure pump 42 that is connected to a discharge conduit 44 and nozzle. The high pressure pump 42 through the discharge conduit 44 can send the fluid to its use and operation as desired by an operator of the system 10, for example, washing items such as automobiles.

Within the third holding tank 16, there is a fluid applicator 46 that adds fluid from an external source in the third holding tank 16. This fluid can be fresh water for washing purposes.

Further, a sensor 50 is included in the third holding tank 16 connected to the logic controller 11. This sensor 50 regulates the amount of liquid within all three compartments by reading the level of the liquid in that third holding tank 16. When the liquid gets to a predetermined level, the sensor 50 activates the discharge pump 34 to discharge the fluid. This sensor 50 can be a float valve, or a high water level sensor, or other sensors known in the art. Additionally, through the fluid applicator 46, fluid can be added to the third holding tank 16 as desired. This can be beneficial for example if there is a need for “make-up water” to properly supply the system 10 for the cleaning as desired. For example, additional fresh make-up water can be added to the third holding tank 16 to supply the high-pressure pump 42 and discharge conduit 44 with a proper amount of water to wash items as intended by the system 10.

In operation, the system 10 can be filled to a desired capacity with fresh liquid, such as water. Each tank has at start-up applied to it fresh water to a desired starting or operating level. Once the high-pressure pump 42 is turned on, water will flow through the dischame conduit 44 to clean items as desired by a user of the system 10. An intake conduit 22 can be proximate the item being washed by the system 10 to collect the used wash water. The intake 22 is connected to a wash water collection containment. Intake conduit 22 can use a force from the vacuum 20 to vacuum up the water into the vacuum tank 18.

During the operation, the water hits the vacuum tank baffle 17 and drops into the vacuum tank 18. The opening 24 is regulated such that the sensor 50 or the vacuum fluid sensor 19 determines via the controller 11 when the opening 24 opens to allow fluid to pass to the first holding tank 12. These switches are connected to a logic controller 11, which can be described as a programmable logical controller generally controlling the operation of the system 10. The opening 24 can be a check valve that closes on a high vacuum pressure and opens on a low vacuum pressure while in the vacuum fluid sensor 19 can be a float switch or other type sensor used to monitor the water level in the vacuum tank 18.

Once the liquid is in the first holding tank 12, it takes the path as previously described moving in front of the baffle 26 with the water flowing under and around to the opening 28 between the first holding tank 12 and second holding tank 14. A coagulant is introduced in compartment 12 via pump 48 and conduit 52. Again, solids fall to the bottom of the first holding tank 12 and can be removed at routine appliance cleanings. As the level of fluid increases in the first holding tank 12 as received from the vacuum tank 18, the water level rises to a point where it enters that opening 28 and flows into the second holding tank 14.

In the second holding tank 14, the liquid flows, as previously described, behind and under the clarifier 32 and through the filtering area of the clarifier 32 up to the opening 36 and into compartment 30. The discharge pump 34 removes excess water. Coagulated particles fall to the bottom of the second holding tank 14 as induced by the introduction of a coagulant into the first holding tank 12. As the fluid rises, it passes through opening 36 and into the third holding tank 16. In the third holding tank 16, water is added as needed through the fluid applicator 46, which can include a liquid conduit. The sensor 50 regulates via the controller 11 when the discharge pump 34 is activated. The applicator 46 can include a valve 47 to regulate the flow of liquid into the third holding tank 16. Valve 47 can be controlled by the logic controller 11.

In a preferred embodiment, the system 10 can contain approximately 360 gallons of liquid, such as water, and can be described as a self-contained wash water recovery system. The system has a modular wash treatment capability that can meet or exceed pretreatment regulations for automobile washing and water discharge. The device can be moved and relocated.

The system 10 can include first, second, and third holding tanks 12, 14, and 16 that can each hold approximately 120 gallons of fluid. The system 10 has a control panel, such as the logic controller 11 that can be a Micrologix 820 PLC other type of programmable controller that can be modified, programmed and preset as desired by the user for efficient operation. The system can be set up for remote control operation of the system 10, such using the Internet via Wi-Fi or other wireless network connectivity.

The system 10 can include a steel tubing exoskeleton frame and high density polyethylene walls and internal dividers between the holding tanks 12, 14 and 16. The system 10 is capable of a totally closed loop operation with a reclamation of approximately 100% of the water used during the washing process. This can be accomplished by gravity separation of oils and settable solids from the water used to clean. A second aspect of the system 10 includes a coagulant mixed into the water to further remove particles from the water. These particles settle to the bottom and can be removed during appliance cleanings. The resulting clean water then overflows into the third holding tank 16 which can have a reservoir for the water used in the cleaning process.

The system 10 can use its high-pressure pump 42 to replace a traditional pressure washer and alleviates bacteria and other items within the water by oxygenation, coagulation, and removal of sludge and sediment.

The system 10 can be programmable to use a preferred, or desired, amount of reclaimed water for return to the cleaning operation. The programmable logic controller 11 can be set for varying percentages of the water to be reclaimed and adjusted based upon the amount of contaminants washed off the automobiles.

Referring now generally to FIG. 1 and one embodiment of the present disclosure provides a system 10 for the reclamation of wastewater during a washing process. The system 10 includes first, second, and third liquid holding compartments 12, 14, and 16, which can also be described as holding tanks or processing tanks. These liquid holding compartments 12, 14, and 16 are fluidly connected to each other.

The first liquid holding compartment 12 is connected to a vacuum tank 18 operatively attached to a vacuum pump 20 and an intake conduit 22. The intake conduit 22 absorbs the fluid with a force imparted by the vacuum pump 20 through the vacuum tank 18. Intake conduit 22 can be those items known in the industry to intake fluid, such as a hose with a proper nozzle or receptacle at the end. Alternately, the intake conduit 22 can be a collection tank used to collect the fluid used in the washing process.

The fluid can be moved through the intake conduit 22 and into the vacuum tank 18 by a vacuum pump 20. Within the vacuum tank 18, there can be a vacuum tank baffle 17 used to direct the fluid into a desired location within the vacuum tank 18. This facilitates the fluid to remain in the vacuum tank 18 and not transfer to the vacuum pump 20. Additionally, a sensor 19 can be positioned within the vacuum tank 18. This vacuum tank sensor 19 can be a sensor used to control the vacuum pump 20. When the fluid level within the vacuum tank 18 reaches the level that registers as full on the vacuum tank sensor 19, the logic controller 11 is commanded to turn off the vacuum pump 20. This disengages the check valve 24 and allows the fluid to flow from the vacuum box 18 through the check valve 24 into the first liquid holding compartment 12. The opening 24 can have a valve or other fluid control to regulate the flow of fluid from the vacuum tank 18 to the first liquid holding compartment 12.

The fluid enters the first liquid holding compartment 12 through an opening in the top and proceeds to a first side of the baffle 26. Particles in the fluid can settle to the bottom of the first liquid holding compartment 12. A coagulant is added through a fluid pump 48 in the holding tank 12 to solidify particles floating within the liquid. These particles will then drop to bottom of the first holding tank 12 and can be later removed by a liquid waste collection company. Within the first holding tank 12, there can be a fluid/gas applicator 51, supplied by an aerator 27 that is operated by the logic controller 11. This can add fluid, such as a liquid or gas, including oxygen, to the liquid in the first holding tank 12. Alternately, this fluid applicator 51 can add other liquids or gases as desired. Oil, since it is lighter than water, will maintain its position on top of the water. Further, since the baffle 26 preferably extends the full width of the first liquid holding compartment 12, the oil will remain on the first side of the baffle. As the water flows down and around the baffle, the oil does not flow with it. On the second side of the baffle 26 is a first transfer channel 28, or first opening, between the first tank 12 and the second tank 14. This first transfer channel 28 can include a filter or valve as desired. This facilitates movement of the liquid from the first holding tank 12 to the second holding tank 14.

As the liquid transfers to the second holding tank 14, a lamella-style inclined plate clarifier 32 is positioned the width of the second holding tank 14. The liquid will enter the second holding tank 14 through transfer channel 28 and pass through the clarifier 32. The clarifier 32 extends the full width, or depth, of the second holding tank 14.

Once the liquid passes through the clarifier 32, it can flow into the top back portion separated by baffle 30 of the second fluid holding tank 14. The discharge pump 34 discharges the cleaned liquid as determined by the water reclaim percentage set in the controller 11. The discharge volume is variable and determined by the water reclaim percentage, which is determined through the pump on-time controlled by controller 11. If no fluid is discharged the fluid passes through an opening 36 between the second holding tank 14 and the third holding tank 16. This opening 36 can include an additional screen, filter, or valve as desired.

The liquid, as it passes through opening 36, enters the third holding tank 16. The third holding tank 16 can include an opening 40 connected to a high pressure pump 42 that is connected to a discharge conduit 44 and/or a hose or nozzle. The high pressure pump 42, through the discharge conduit 44, can send the fluid to its use and operation as desired by an operator of the system 10, for example, washing items such as automobiles.

Further, a sensor 50 can be included in the third holding tank 16. This sensor 50 can regulate the amount of liquid within the third holding tank 16 by reading the level of the liquid in that third holding tank 16. This sensor 50 can be a high water level sensor, or other sensors known in the art. When a high water level is sensed, the system controller 11 will turn on the discharge pump 34 to discharge the excess fluid via the discharge pump 34.

Additionally, through the fluid applicator 46, additional fluid can be added to the third holding tank 16 as desired. This occurs if there needs to be fresh water to properly supply the system 10 for the cleaning as desired. For example, additional fresh water can be added to third holding tank 16 to supply the high-pressure pump 42 and discharge conduit 44 with a proper amount of water to wash items as intended by the system 10.

### Operation

In operation, the system 10 can be filled to a desired capacity with fresh liquid, such as water. Each tank can have applied to it fresh water to fill them up to a desired starting or operating level. Once the high pressure pump 42 is turned on, water will flow through the discharge conduit 44 to clean items as desired by a user of the system 10. An intake conduit 22 can be routed to the area where the item is being washed by the system 10. The intake conduit 22 can use a force from the vacuum air pump 20 to suction water into the vacuum tank 18.

During operation, the water can hit the vacuum tank baffle 17 and drop into the vacuum tank 18. The opening 24 can be regulated such that the fluid sensor 19 can regulate when the opening 24 opens to allow fluid to pass to the first holding tank 12. These switches are connected to a logic controller 11, which can be described as a programmable logical controller which can generally control the operation of the system 10. The opening 24 can be a check valve that can close on a high vacuum pressure and open on a low vacuum pressure while in the vacuum fluid sensor 19 can be a float switch or other type sensor used to monitor fluid in the vacuum tank. Gases, such as oxygen can be added through the fluid applicator 51, which can include a liquid conduit or a gas conduit, or aerator while in the first holding tank 12.

Once the liquid is in the first holding tank 12, it takes the path as previously described moving in front of the baffle 26 with the water flowing under and around to the opening 28 between the first holding tank 12 and second holding tank 14. Again, solids can fall to the bottom of the first holding tank 12 and be held for collection and disposal by a waste collection service company. As the level of fluid increases in the first holding tank 12 as received from the vacuum tank 18, water is pushed through opening 28 and flows into the second holding tank 14.

In the second holding tank 14, the liquid flows, as previously described through the lamella-style clarifier 32 to the opening 36. Discharge pump 34 is turned on/off by the controller 11 discharging liquid as needed to achieve the selected reclaim percentage. As the fluid rises in tank 14, it passes through opening 36 and into the third holding tank 16. In the third holding tank 16, fresh water can be added through the fluid applicator 47, which can include a liquid conduit. Liquid applicator 46 via valve 47 is used to replenish fluid discharged by pump 34, which is regulated by controller 11. The sensor 50 regulates via logic controller 11 when the discharge pump 34 is activated. If the liquid rises past a certain level the sensor 50 will detect that the system 10 has a surplus of liquid and will engage the discharge pump 34 to decrease the fluid level.

The applicator 46 can include a valve 47 to regulate the flow of liquid into the third holding tank 16. If the fluid levels are low, this valve 47 may add additional fluids to the third holding tank 16.

In a preferred embodiment, the system 10 can contain liquid, such as water, and can be described a self-contained wash water recovery system. The system has a modular wash treatment capability that can meet or exceed pretreatment regulations for automobile washing and water discharge. The device can be moved and relocated.

The system 10 can include first, second, and third holding tanks 12, 14, and 16 that can each hold fluid. The system 10 has a control unit, such as the logic controller 11 that can be a Micrologix 820 PLC or other programmable logic controller that can be modified, programmed and preset as desired by a user for an efficient operation. The system can be set up for remote control operation of the system 10, such as by the internet via WiFi connectivity.

The system 10 can include a steel tubing exoskeleton frame which contains the containers 12, 14 and 16 which can consist of high density polyethylene walls and internal dividers. The system 10 is capable of a totally closed loop operation with a reclamation percentage of approximately 100% of the water used during the washing process. This can be accomplished by gravity separation of oils and settleable solids from the water used to clean objects. A second aspect of the system 10 includes a coagulant mixed into the water to further remove particles from the water. These particles will settle to the bottom and are removed at regular cleaning intervals performed by liquid waste collection entities. The resulting clean water then overflows into the third holding tank 16 which can have an external reservoir for the water used in the cleaning process.

The system 10 can use its high-pressure pump 42 to replace a traditional pressure washer. Introduction of process aides alleviate bacteria/odor problems and other contaminants within the water by oxygenation, coagulation, and removal of sludge and sediment.

The system 10 can be programmable to use a preferred, or desired, amount of reclaimed water for return to the cleaning operation. The system controller 11 can be set to allow the percentage of the water to be reclaimed and adjusted based upon the amount of contaminants washed off the automobiles. The system 10 can allow anywhere from 100% reclamation to 0% reclamation. The 100% reclamation means no water is discharged into a secondary system, such as a sewer, while 0% reclamation means completely fresh water is available to be used to wash the automobiles. In most instances, a relative mix of some fresh water and reclaimed water is used as it increases the effectiveness of the washing system.

Various timings and controls of the system 10 can be pre-programmed and modified at the programmable logic controller 11. This can include various timings for pumps and various inputs from the sensors to control those pumps. This control can also include the operation of the valves allowing fluid to flow to and from the various tanks. In some embodiments, the pumps can be programmed to run continuously to remove items such as sludge and sediment from the water, while at other times, these pumps can be programmed off and on as desired by the user.

Thus, it is seen that the apparatus and methods disclosed herein achieve the ends and advantages previously mentioned. Numerous changes in the arrangement and construction of the parts and steps will be readily apparent to those skilled in the art, and are encompassed within the scope and spirit of the present disclosure.

The system 10 allows the collection of wash water from the lowest point of a wash area without disturbing or digging into existing wash area surface levels.

System 10 is a chattel, moveable automobile wash system comprising: a frame; a vacuum pump system attached to the frame, a discharge pump to allow pressure discharge of unwanted liquid, the vacuum collecting used fluid from the wash system; a plurality of processing tanks operatively attached to the tanks and the frame, each tank processing the fluid in the wash system and supplying fluid to the wash system wherein the system allows the collection of used wash water from the lowest point of a wash area without the need to need to dig into the surface of the wash area.

1) A moveable washing system for reclaiming and processing fluid, comprising of: a first holding compartment for holding the fluid;
a second holding compartment in fluid communication with the first holding compartment;
a third holding compartment in fluid communication with the second holding compartment;
a frame to support the movable washings system; and wherein the movable washing system is movable across the support surface.

2) A moveable washing system for reclaiming and processing fluid as in claim 1, wherein the movable washing system includes an inlet conduit to receive the fluid.

3) A moveable washing system for reclaiming and processing fluid as in claim 2, wherein the movable washing system includes a vacuum tank connected to the inlet conduit.

4) A moveable washing system for reclaiming and processing fluid as in claim 2, wherein the vacuum tank is connected to a vacuum device to generate a vacuum.

5) A moveable washing system for reclaiming and processing fluid as in claim 1, wherein the first holding compartment includes a tank baffling device to baffle the input fluid.

6) A moveable washing system for reclaiming and processing fluid as in claim 3, wherein the vacuum tank includes a sensor to control the fluid level within the vacuum tank.

7) A moveable washing system for reclaiming and processing fluid as in claim 1, wherein the first holding compartment is connected to the second holding compartment by a first transfer channel.

8) A moveable washing system for reclaiming and processing fluid as in claim 7, wherein the first transfer channel includes a filter to prevent larger particles to enter the second holding compartment.

9) A moveable washing system for reclaiming and processing fluid as in claim 1, wherein the second holding compartment includes the discharge pump to remove unwanted fluid from the second holding compartment.

10) A moveable washing system for reclaiming and processing fluid as in claim 1, wherein the second holding compartment includes a clarifier.

11) A moveable washing system for reclaiming and processing fluid as in claim 10, wherein the clarifier includes a plurality of inclined plates.

12) A moveable washing system for reclaiming and processing fluid as in claim 1, wherein the third holding compartment is attached to a high pressure pump to use the cleaning fluid for washing an object.

13) A chattel, moveable automobile wash system comprising: a frame; a vacuum air pump system attached to the frame, a discharge pump to allow discharge of unwanted liquid, the vacuum collecting used fluid from the wash system; a plurality of processing tanks operatively attached to the tanks and the frame, each tank processing the fluid in the wash system and supplying fluid to the wash system; wherein the system that allows the collection of wastewater from the lowest point of a wash area without the need to dig into the surface of an existing wash area.
